(19) United States
(12) Patent Application Publication
(10) Pub. No.: US 2012/0236442 A1
(43) Pub. Date: Sep. 20, 2012

(54) INTELLIGENT CONTROLLER

(76) Inventors: Manchanahally Venkataramasastry Satyanarayana, Bangalore (IN); Srikanth Kashyap Satyanarayana, Bangalore (IN)

(21) Appl. No.: 13/512,912

(22) PCT Filed: Dec. 2, 2009
(86) PCT No.: PCT/IN2009/000699

§ 371 Date: May 31, 2012

(51) Int. Cl. H02H 7/04

(52) U.S. Cl. 361/35

(57) ABSTRACT

Described herein is an intelligent controller for management and control of electrical distribution transformer either located within the transformer or outside the transformer, housed in a separate enclosure and mainly comprising: a. input terminals (3,4) wherein the distribution transformers output is terminated; b. output terminals wherein the load is terminated (3.8(1), 3.8(2)); c. a power supply derived internally; d. a set of built-in contactors (3.7(1), 3.7(2)) to control the load; e. a set of in-built transducers, programmable digital input and output terminals; f. a communicable Real Time Embedded System (3.11) whose Operating characteristics can be programmed either through a local MMI or through a wired &/wireless communication interface after proper user authentication; and g. a capacitor (3.9(1), 3.9(2)) to improve the PF of the load, said-capacitor bank (3.9(1), 3.9(2)) is controlled by the RTES (3.11).

### BACKGROUND OF THE INVENTION

1. Technical Field

This invention relates to an Intelligent Controller to be used along with or built in to electrical distribution transformers, motors, inductors and outdoor unattended electrical equipment which are load sensitive.

The intelligent controller of the present invention helps in the management and control of electrical distribution transformer for its safe working, automatic control, measurement of electrical parameters, improvement of power factor, fault recording, event recording, load-flow data recording, storage and communication of performance parameters. Though this invention will be described hereinafter with reference to electrical distribution transformers, the said controller could be used along with motors, inductors and outdoor unattended electrical equipment which are load sensitive.

2. Prior Art

Distribution Transformer—Its Operation and Working Conditions:

Electrical distribution transformers are static equipment that are used to convert electrical power at higher voltages to lower voltages and enable the consumers to operate all their devices, be it domestic, agricultural or industrial nature. Typically, distribution transformers provide a power supply at 400/440, V 3phase-4wire or 215-240 V, single phase, 2-wire to consumers by receiving 3-phase power supply at 11 kV, 22 kV or 33 kV from power lines.

Distribution transformers are classified as oil cooled or air-cooled based on the means of cooling used. They are either pole mounted or pedestal mounted. As the terminals are live, they are kept at an elevated place and are usually guarded by fence around them to avoid accidental contact with human beings or animals.

The distribution transformer is the last major equipment in the power supply chain and is supposed to work at all times to ensure continuous power supply to the consumers. The failure of a transformer disrupts power supply to all consumers fed by it consequently results in inconvenience to consumer, loss of revenue and goodwill to the supply company.

A transformer is static equipment with no moving parts. It mainly comprises of two windings termed primary and secondary, wound around a magnetic core. When the primary winding is fed with power at a specified voltage as input, the secondary winding delivers the power at a different specified voltage through electromagnetic induction.

The primary and secondary windings are separated by adequate insulation between them and also between windings and core. The power input to the transformer is equal to the sum of power output and power loss in the transformer. The efficiency of the transformers is very high (typically 98 to 99%). The capacity or rating of a distribution transformer is specified in kVA and depending up on the operating power factor, the output power is calculated in kilowatts. This when multiplied by time of usage in hours gives the output energy in kilowatt hours known as a “unit”.

The power loss in a transformer will result in heating and is proportional to its size and the load fed by the transformer. The performance will be within safe limit as long as the load on the transformer does not exceed its capacity. Various standards such as BIS, IEC and BS have specified the operating characteristics for transformers. These characteristics are known as “Thermal characteristics” and are typically specified for both hot and cold working conditions of the transformers. The thermal time constant, which determines the time required to raise the temperature of transformer depends on the size, weight and its rating.

OVER LOAD: The loading of the distribution transformers varies from light loading to over loading state depending on the nature of the load, weather conditions and the like. For example, on a very hot day, during peak hours, load due to air conditioner might be predominant; on a very cold day, load due to heaters might be predominant.

Continuous change in the internal temperature of the transformer will result in thermal stress on the insulation and results in progressive degradation in its property. Excessive operating temperature may lead to burn out or the failure of insulation inside the transformer.

SHORT CIRCUIT: Accidental short circuit of terminals of outgoing conductors or snapping of a conductor and accidentally falling on ground or on a tree, may also cause excess current flow in the windings. These faults may cause severe damage to windings and at times causes “burning out” of the windings.

SWITCHING SURGES: Sudden loading of the transformer from “no load” to “full load” will result in high, electrical and mechanical stress on the core and winding. Repetition of the phenomenon will result in structural defects, winding and insulation failure. Eventually such stresses will damage the distribution transformer.

OVER VOLTAGE conditions, which may be as a result of neutral conductor, disconnection or phase conductor coming in contact with neutral conductor may cause excessive voltage on single phase loads connected to the transformer. This may result in damage to the appliances that are connected at consumer premises. Similarly, an UNDER VOLTAGE situation may result in the incorrect operation of some gadgets like computers, food mixers, washing machines etc.

PHASE SEQUENCE REVERSAL: All 3 -phase appliances are designed in such a way as to operate correctly if the 3-phase voltages impressed at their input terminals have a positive phase sequence i.e. V<−V_{Y}<−VB or V_{Y}<−V_{B}<−V_{R} or V_{B}<−V_{R}<−Vy.

Occasionally, due to incorrect wiring of the 3-phase lines, probably during maintenance work, phase sequence gets reversed viz. Vy<−VR<−V_{B}. Consequently 3-phase appliances might operate incorrectly.

POWER FACTOR IMPROVEMENT: The total power available from distribution transformer is decided by its rating (kVA). The load power factor (PF) dictates the amount of effective power (measured in terms of kW) utilized by the distribution network.

Effective power=(Total power)×(Power factor)

The maximum value of PF is T and the minimum value is ‘O’. It is usually observed that the PF is less than T due to inductive loads. By suitably connecting capacitor banks, the PF can be improved to a value near unity. This improvement will enable the optimal usage of available Total power at the transformer.

The “prior art” is briefly described with reference to the following figures:

FIG. 1 shows the distribution transformer in its typical working condition;

FIG. 2(a) shows an improvement in the usage of distribution transformer; and

FIG. 2(b) shows an improvement in the usage of distribution transformer power factor.

FIG. 1 shows the distribution transformer in its typical working condition. The primary winding ‘P’ of the distribution transformer 1.3 is connected to the high voltage power through fuse 1.2 and a disconnecting switch 1.1. The secondary winding ‘S’ provides low voltage power to consumer at its terminal 1.4 either directly or through a secondary fuse 1.5.

FIG. 2(a) shows an improvement in the usage of distribution transformer. While primary winding ‘P’ continues to be as in FIG. 1, the secondary winding is terminated in to a control cabinet, which is equipped with a trivector meter 2.5. The trivector meter is used to measure and record power out flow of the transformer. The measuring current of trivector meter is received through current transformer 2.7 and measuring line voltage is received directly from the transformer secondary. Manually operated circuit breaker 2.6 (either one or more) is used for manual load control, which will also trip when a short circuit is seen on the load side.

FIG. 2(b) is identical to FIG. 2(a) in all respects with an addition of a power factor improvement capacitor 2.8, which is always connected on the load side. Further, the meter 2.5 with CT 2.7, the circuit breaker 2.6 and capacitor 2.8 are housed in independent pole mounted control cabinets and are interconnected by cables.

While the arrangement as in the FIG. 1 offers no protection, the arrangement in FIG. 2(a) has the facility to record the power flow to the load and keep track of the “units” consumed. It also has independent manually controlled circuit breakers, which are thermal magnetic devices and operate on excessive current flow, which normally happens in the event of short circuit on load side. Arrangement in FIG. 2(b) is same as in FIG. 2(a) with the addition of a capacitor bank for power factor improvement, which, is permanently connected although the capacitor bank has to be connected or disconnected, based on its need.

While the arrangement in FIG. 1 fail to protect the transformer in case of overload or short circuit or any fault on load side, the arrangement shown in FIGS. 2(a) and 2(b) satisfies the limited purpose of energy measurement. As the operating characteristics of manually operated circuit breakers are quite different from that of the transformer, there is a large mismatch in the operating time. Most of the times, the circuit breaker does not operate for overloaded condition of the transformer and results in transformer failure, much before the tripping of the circuit breaker. Further, as the thermal elements of circuit breakers are of bi-metal, their operating characteristics are subject to severe variations depending upon the load current, ambient temperature, and length of connected cable and factor of aging. Since they are essentially manually operated, re-starting needs human intervention. Many times to avoid frequent human intervention for manual re-close, the operating values are set at higher than normal, resulting in failure of protection function. The current ratings of the transformer output and that of the circuit breaker normally do not match each other, which, also results in failure of intended protection. For this reason, arrangement of FIG. 2(a) and FIG. 2(b) fail to protect the transformers whenever it is working at full load or light overload conditions. Other than the arrangements discussed as in the FIGS. 1, 2(a) and 2(b) there is no specific equipment that is solely meant to protect the distribution transformer from burning-out during sustained or cyclic overload or short circuit condition.

There are also a number of patents relating to circuit breakers, which will trip when a short circuit is seen on the load side. However, there is a large mismatch in the operating time of the circuit breaker and that of the transformer and during overload conditions the circuit breaker does not operate resulting in the failure of the transformer.

Presently, distribution transformers are working without proper protection. They always work under the risk of burnout. Annually, thousands of transformers burn-out resulting in expensive repairs. Even after repairs, they are back to service only to work under the same risky conditions. Owners of distribution transformers incur huge cost of repair, loss of revenue for the period of its outages and loss of reputation. They are unable to monitor the transformer performance and loading pattern. Consumers are greatly inconvenienced during the period of outages.

### BRIEF SUMMARY OF THE INVENTION

Accordingly, it is the primary object of the present invention to provide an intelligent controller that will address all these problems and make the transformer work as an intelligent machine with all desirable features for its safe and efficient working. The intelligent controller of the present invention will help in the safe working, automatic control, measurement of electrical parameters, improvement of power factor, fault recording, event recording, load flow, storate and communication of performance parameters of the distribution transformers.

Present invention:

The architecture, and method for distribution transformer protection and management:

The invention is described in more details hereunder:

To avoid distribution transformer burnouts, it is necessary to ensure its safe working at all times. Controller meant for its purpose must be self contained, adaptable, safe, mounted as an integral part or adjacent to transformer. Apart from meeting the performance requirements of a transformer, the controller should be tamper proof, weather proof, mechanically strong and have a long service life. Its installation must be simple and operation should be highly reliable.

### BRIEF DESCRIPTION OF THE DRAWINGS

The “architecture and the method” of working of the Intelligent Controller for distribution transformer is now explained with reference to the following figures:

FIG. 1 shows the distribution transformer in its typical working condition;

FIG. 2(a) shows an improvement in the usage of distribution transformer;

FIG. 2(b) shows an improvement in the usage of distribution transformer power factor;

FIG. 3 shows Functional architecture of intelligent controller;

FIG. 4 shows Functional architecture of RTES;

FIG. 5 shows a flow chart of over current—phase and earth fault protection logic;

FIG. 6 shows a flow chart of Thermal over load protection, auto re-close and load control logic;

FIG. 7 shows a flow chart of Reverse phase sequence protection logic;

FIG. 8 shows a flow chart of Under and Over voltage protection and auto re-close logic;

FIG. 9 shows a flow chart of Power factor control logic;

FIG. 10 shows the screen shot of Settings & real time display of line voltage, currents and PF (obtained through communication block 4.6 (FIG. 4)) as seen on a host computer;

FIG. 11 shows the screen shot of a Fault record (obtained through communication block 4.6 (FIG. 4)) as seen on a host computer;

FIG. 12 shows the screen shot of a Event records (obtained through communication block 4.6 (FIG. 4)) as seen on a host computer; and

FIG. 13 shows screen shot of a Load flow data (obtained through communication block 4.6 (FIG. 4)) as seen on a host computer.

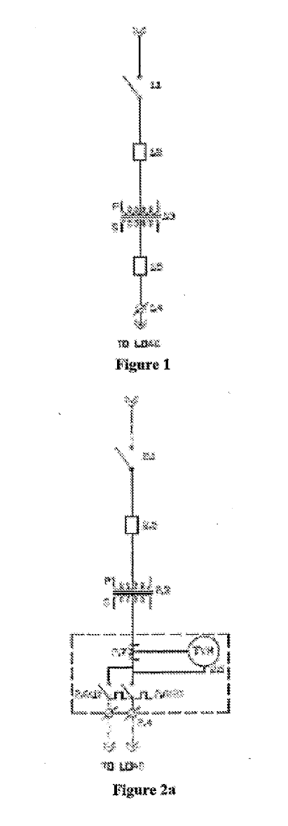

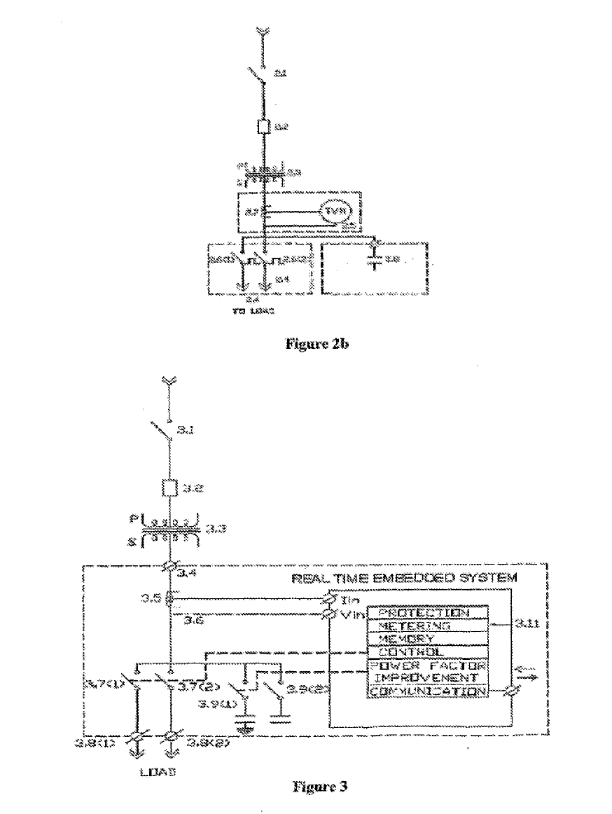

### DETAILED DESCRIPTION OF PREFERRED EMBODIMENTS

FIG. 3 describes the functional architecture of the intelligent controller. The intelligent controller is a self-contained unit that can be fixed as an integral part of the distribution transformer or mounted as a separate unit near the distribution transformer. The distribution transformer power output is connected to the input terminals 3.4 of the controller, and the load is connected to 3.8(1), 3.8(2) terminals. The type of connection could be direct plug-in arrangement or through conventional cable termination.

The input terminal 3.4 is connected through a measuring current transformer 3.5 to the incoming terminals of one or more power contactors 3.7(1), 3.7(2) which are electrically operated. The output terminals of these contactors 3.7(1), 3.7(2) are terminated in the controller at 3.8(1), 3.8(2) to which load is connected.

A separate set of one or more contactors 3.9(1), 3.9(2) are used in the controller to connect and disconnect internally mounted capacitor bank to improve the load power factor. The operation of the power contactors 3.7(1), 3.7(2) and the switching function of contactor 3.9(1), 3.9(2) are intelligently controlled by a real time embedded system 3.11.

The real time embedded system (RTES) 3.11 is the heart of the intelligent controller and derives power for its operation from the voltage signals connected to it and does not need a separate power supply. The RTES receives signals from current transformer 3.5 and line voltage 3.6 at its input terminals. These signals are continuously monitored and processed within the RTES by a set of software programs embedded and executed as separate but interlinked functions for protection, control, power factor improvement, metering, data storage and communication. The power contactors 3.7(1), 3.7(2) switches ON or OFF as dictated by the logic embedded in the RTES depending on the exacting needs of the distribution transformers safe performance needs. Similarly the capacitor switching contactors 3.9(1), 3.9(2) are switched ON or OFF as dictated by the logic within the power factor-measuring module of the RTES to keep load power as nearer to unity as possible.

The function of other modules of RTES (3.11) in the controller are as under:

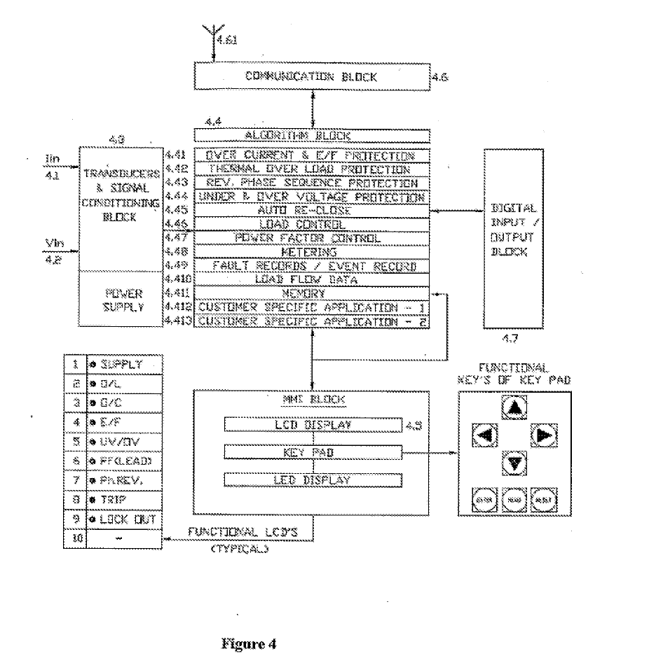

The functional architecture of RTES and its internal modules are explained in greater detail with the help of FIG. 4.

4.1 and 4.2 are the current and voltage inputs derived from line current transformer and voltage transformer connected to the output of the distribution transformer. These input signals are received and processed to provide proportional output signals by transducers and signal conditioning block (4.3). The power supply block (4.31) provides the necessary power for the operation of RTES. 4.4 is an algorithm block which comprises of hardware and software algorithm to achieve the specific operational requirement of different functional blocks. This block (4.4) receives inputs from transducer block 4.3, man machine interface 4.5 through keypad, digital inputs from 4.7 and remote instructions through communication port 4.6. The calculations, comparison, and verification of data pertaining to measured value and desired value of each of the performance parameters are carried out in this block (4.4). The algorithm block carries out its operation precisely according to a set of software instructions. The algorithm block provides its output in three forms simultaneously to MMI block 4.5, communication block 4.6 and digital output block 4.7. MMI block 4.5 comprises of an LCD (liquid crystal display), LEDs (light emitting diodes) and a keypad. Real time values are continuously displayed on the LCD as also the status of RTES outputs. The LCD along with keypad acts as a input-output device with which users can access the functions of the RTES. Status of the algorithm block (4.4) is indicated through a set of LEDs. Communication block (4.6) helps in configuration of RTES and acquisition of real time values, event and fault records and load flow data though a wired and/or a wireless port. User defined logic functions can be synthesized in to programmable digital input/output block (4.7).

The information or instruction inputs to the algorithm block through man machine interface keypad 4.5 and through communication port 4.6 are through multilevel password security. This is to safeguard the system against unauthorized access.

Protection and Control modules (FIG. 4, Blocks 4.41 through 4.47):

The protection module will monitor the status of the load currents and line voltages. If the protection module detects an abnormal status in the form of over load and/or over current and/or over voltage and/or under voltage, the module provides a control signal to 3.7(1) and 3.7(2) so as to isolate the loads from the distribution transformer either partially or completely. The module also provides a visual alarm to indicate “phase reversal” which, will reset when the phase sequence gets corrected.

In the case of an over load phenomenon, the loads are selectively isolated based on a priority logic and thermal characteristics of the transformer. The loads are reconnected to the transformer through an auto re-close logic after allowing the transformer to sufficiently cool down.

In the case of over current phenomenon, the loads are disconnected from the transformer until further manual intervention to reset the RTES.

In the case of over voltage/under voltage phenomenon, the loads are disconnected and are reconnected after the line voltages return to their normal values.

The power factor improvement module measures the load power factor and operates the capacitor bank to maintain the power factor close to unity.

Communication module (FIG. 4, Blocks 4.6):

Modification of configuration data and acquisition of measured and derived values contained within RTES can be accessed through a wired and/or a wireless communication module.

Metering and memory modules (FIG. 4, Block 4.48 and 4.411):

The instantaneous values of line currents, line voltages and average power factor is displayed in the LCD screen which form a part of the man machine interface present in RTES. Fault and event records AND load flow data comprising of line voltages, line currents, power factor, total power, active power and reactive power are logged in the memory module and can be retrieved through a wired and/or a wireless communication port.

The method of operation:

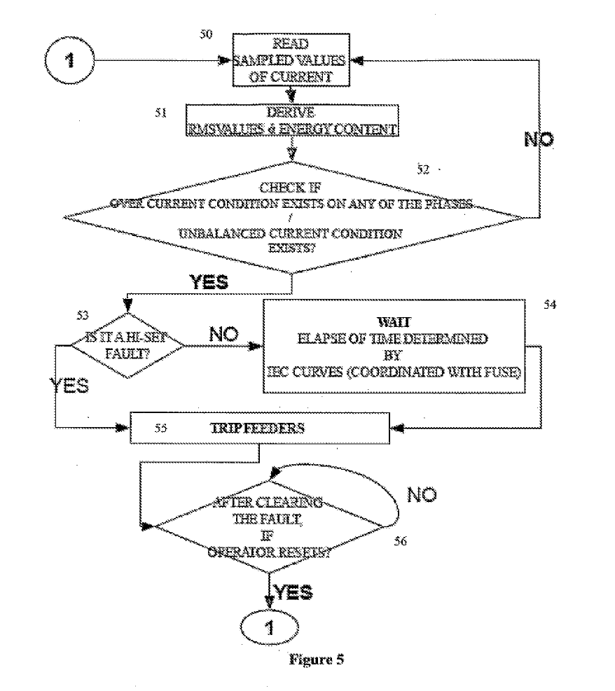

The sequential logic (algorithm) present inside each of the “functional blocks” (4.41 through 4.47) contained within the algorithm block, designated as 4.4 (FIG. 4) is discussed hereunder (Refer FIGS. 5, 6, 7, 8 and 9): Sequential logic is formally represented as a “flow graph”.

All the flow graphs receive its relevant “sampled value” inputs from transducers and signal conditioning block (FIG. 4, 4.3). The configuration parameters of algorithm block (FIG. 4, 4.4) are programmable either with the help of MMI block (FIG. 4, 4.5) or communication block (FIG. 4, 4.6). These configurable parameters of the algorithm block (FIG. 4, 4.4) influence the operation of the flow graphs.

The output of the flow graphs drive the MMI block (FIG. 4, 4.5) and digital input/output block (FIG. 4, 4.7).

FIG. 5 shows the flow chart of an over current—phase and earth fault protection logic (refer block 4.41 of FIG. 4). Said logic reads sampled values of current 50 and it derives RMS values proportional to the energy content 51 followed by a check if over current condition exists on any of the phase or unbalanced current condition exits 52. If not, it reads sampled values of current 50; if yes it checks to see for hi-set fault 53. If there is no hi-set fault, it waits for an elapse of time determined by EEC curves (co-ordinated with fuse) 54 and information is given to trip feeders 55 and if there is a hi-set fault, the information is given to trip feeders instantaneously. After clearing the fault, if operator resets 56 then the process flow will revert back. If operator does not reset then the process will wait in state 56.

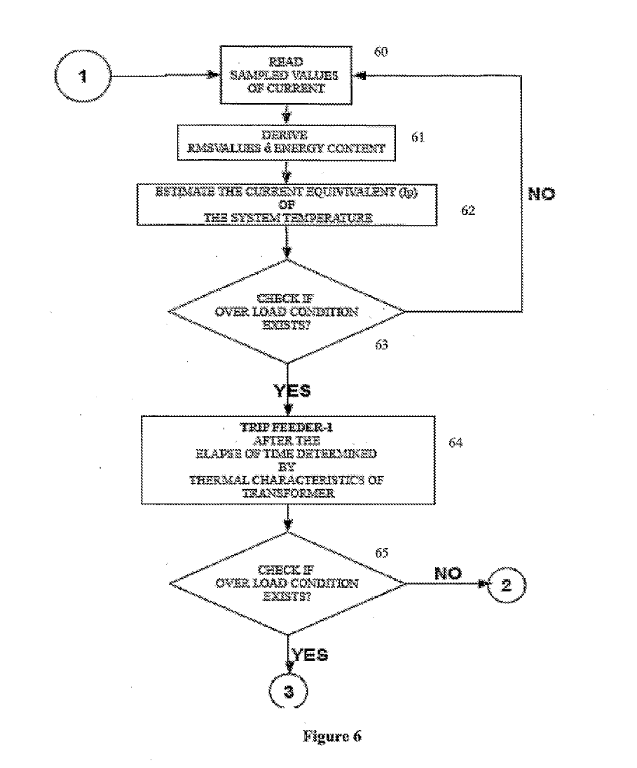

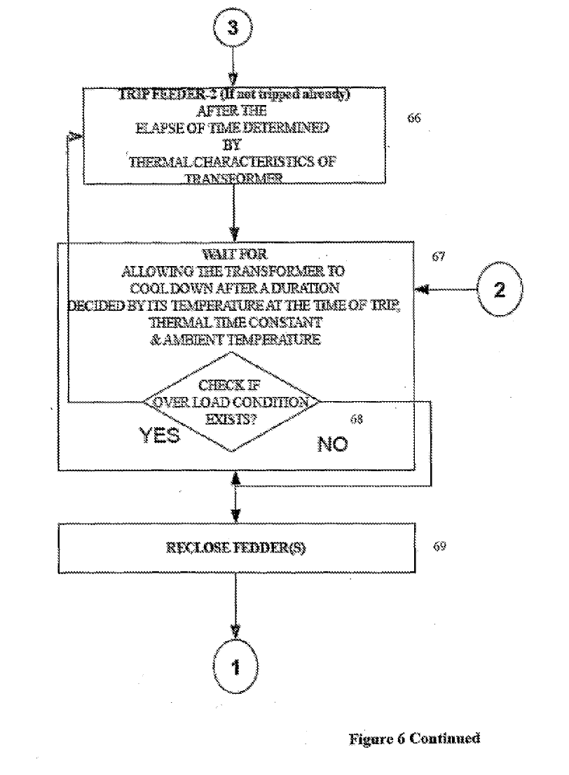

FIG. 6 shows the flow chart of thermal over load protection, auto re-close and load control logic. (Refer to blocks 4.42, 4.45 and 4.46 of FIG. 4). Said logic reads the sampled values of current 60, derives RMS values proportional to energy content 61 and estimates the current equivalent (Ip) of the system temperature 62 followed by a check if over load condition exists 63. If the over load condition does not exist, the process will loop back to 60. If yes, after an elapse of time determined by thermal characteristics of transformer 64 feeder 1 will be tripped and a check for over load condition are performed 65. If in 65 the result is yes, after an elapse of time determined by thermal characteristics of transformer feeder 2 is tripped 66 (if not tripped already) and wait 67 until the transformer sufficiently cools down. If in 65 the result is no, then the flow branches to 67. While the process is in 67, if over load condition occurs 68, then feeder 2 is tripped. If in 68 the no over load condition is detected then, feeders will be reclosed 69 and the process will loop back to 60.

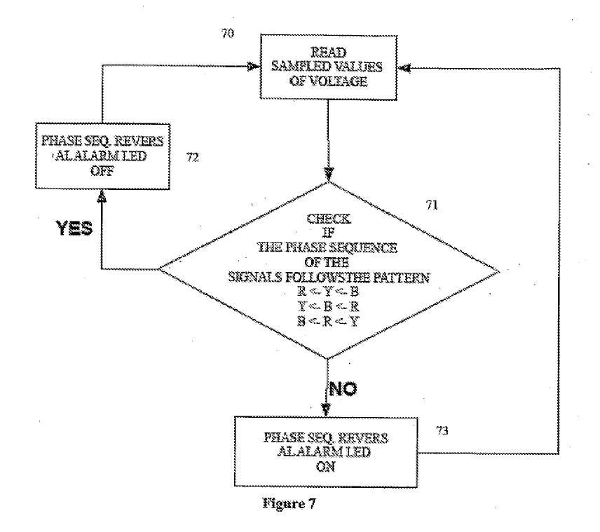

FIG. 7 shows the flow chart of reverse phase sequence protection logic, referred in block 4.43 of FIG. 4, wherein the process starts with the reading of sampled values of voltage 70 followed by a check to see if the phase sequence of the signals follows the pattern R<−Y<−B; Y<−B<−R; B<−R<−Y 71. If so the phase sequence reversal alarm led is switched off 72 and returns to 70. If not the phase sequence reversal alarm led is switched on 73 and the process will return to 70.

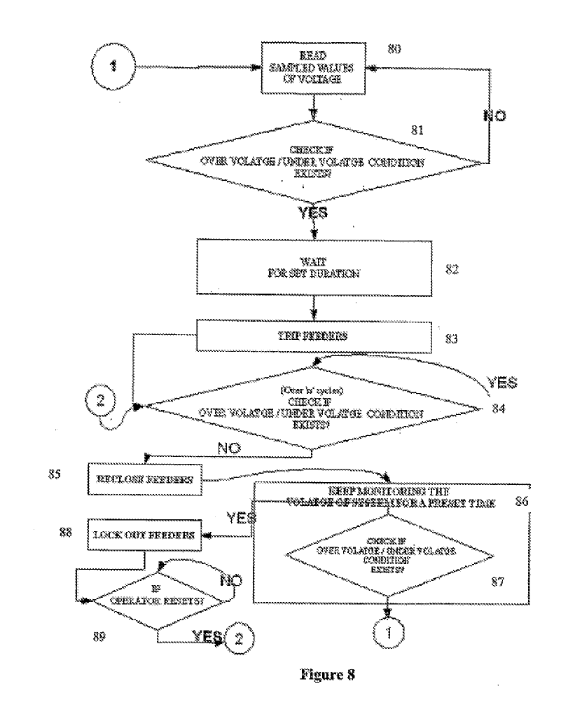

FIG. 8 shows the flow chart of under and over voltage protection and auto re-close logic, referred in blocks 4.44, 4.45 of FIG. 4, wherein the process starts with the reading of sampled values of voltage 80 followed by a check to see if the over voltage/under voltage condition exists 81. If not the process will loop back to 80. If 81 returns yes, wait for a set duration 82 and a signal to trip feeders 83 is issued. The voltages are continuously monitored while the feeders are in a state of disconnection 84. When the voltage condition reverts to acceptable levels (voltage measured over ‘n’ cycles) 84, the feeders are re-closed 85. Following a re-close of feeders 85, the process enters a state 86 where the voltages are monitored for a predetermined time, within which, if any over/under voltage condition is detected, then the process enters LOCK OUT state 88. While in the LOCK OUT state, if an operator resets the process, the flow will branch to 84. If the voltages are found to be normal, during 86, then process loops back to 80.

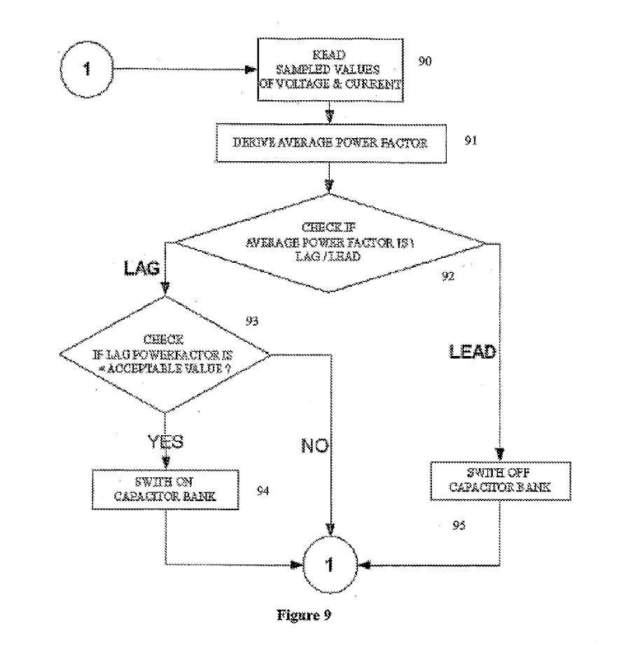

FIG. 9 shows the flow chart of Power factor control logic, referred to in block 4.47 of FIG. 4, wherein the process starts with the reading of sampled values of voltages and currents 90 and it derives average power factor 91 followed by a check to see if the average power factor is Lag Lead 92. If power factor is Lag a check is made to see if lag power factor is less than the acceptable value 93, if so switch on 94 capacitor bank. If not, the entire process will start again. If the power factor is lead, the capacitor bank is switched off 95 and the process continues from the beginning.

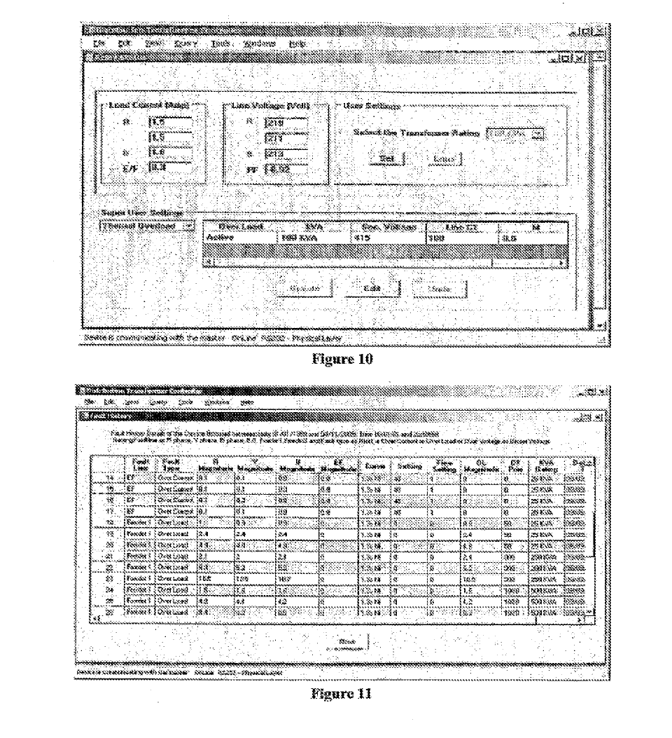

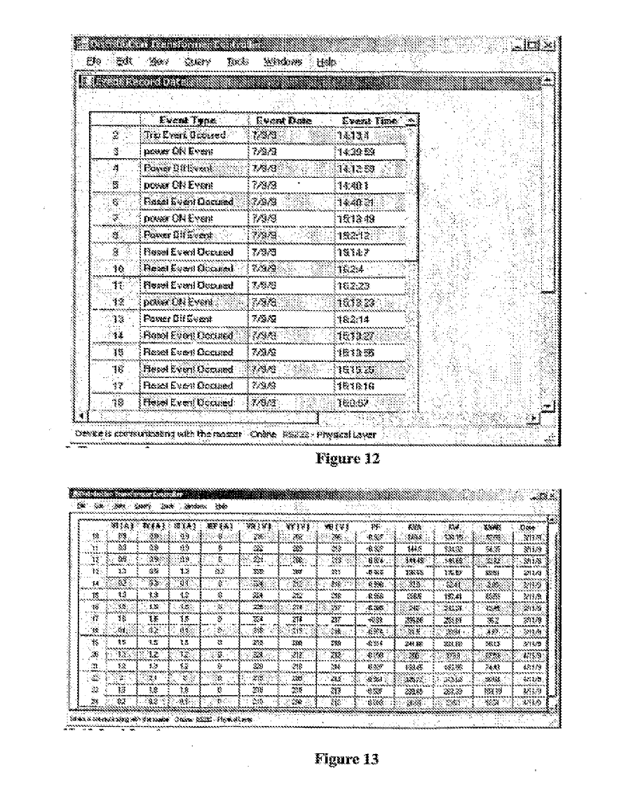

FIGS. 10 through 13, depicts the “graphic user interface” available on a host computer and/or a hand held device. This “graphic user interface” along with the communication block 4.6 (FIG. 4) and its wired/wireless interface is used to perform “supervisory control” of the intelligent controller and “data acquisition” from the intelligent controller.

List of abbreviations, symbols, phrases and jargons

| S1 | | |
|---|---|---|
| No. | Abbreviations | Expansion |
| 1 | IEC | International Electrotechnical Commission |
| 2 | BIS | Bureau of Indian Standards |
| 3 | BS | British Standards |
| 4 | A | Ampere |
| 5 | V | Volt |
| 6 | kVA | Kilo Volt Ampere |
| 7 | kVAR | Kilo Volt Ampere Reactive |
| 8 | kW | Kilo Watt |
| 9 | RMS | Root Mean Square |
| 10 | PF | Power Factor |
| 11 | CT | Current Transformer |
| 12 | RTES | Real Time Embedded System |
| 13 | LCD | Liquid Crystal Display |
| 14 | LED | Light Emitting diode |
| 15 | MMI | Man Machine Interface |

Symbols & Jargons

| S1 | Symbols & | |
|---|---|---|
| No. | Jargons | Expansion |
| 1 | α | “Proportional to” |
| 2 | X | Multiplication operator |
| 3 | V_{R}, V_{Y}, V_{B} | ‘V’ represents RMS value of line voltage |
| | | R, Y & B represent phase designation |
| 4 | IR, IY, IB | ‘T’ represents RMS value of line current |
| | | R, Y & B represent phase designation |
| 5 | Trip | The word refers to an action taken by a breaker or a |
| | | switch present in an electric circuit so as to interrupt |
| | | the flow of current through it |
| 6 | Feeder | The word refers to an electric circuit in “power |
| | | systems” that Connects an electric source to |
| | | a load. Some times feeder is interchangeably used |
| | | with the word load (as in the case “feeder ripped |
| | | is equivalent to load disconnected” |
| 7 | Signal | This refers to either a analog or digital signal. |
| | | Analog signals can have a strength continuously |
| | | valued (theoretically infinite number of states) |
| | | and can be periodic or aperiodic. Digital signals |
| | | can either have a logic ‘0’ or logic ‘1’ as |
| | | its state and can be either periodic or aperiodic |
| 8 | Sampled | The phrase refers to a “digital signal processing” |
| | values | technique wherein “continuous valued, continuous |
| | | time signal” is converted to “discrete valued, |
| | | continuous time signal”. |

What is claimed is:

1. An intelligent controller for management and control of an electrical distribution transformer either located within the transformer or outside the transformer, housed in a separate enclosure and comprising:
a. input terminals wherein the distribution transformer's output is terminated;
b. output terminals wherein the load is terminated;
c. a power supply derived internally;
d. a set of built-in contactors to control the load;
e. a set of in-built transducers, programmable digital input and output terminals;
f. a communicable Real Time Embedded System whose operating characteristics can be programmed either through a local MMI or through a wired and/or wireless communication interface after proper user authentication and comprising of:
i. means to derive the operating characteristics based on the power rating of the distribution transformer;
ii. means to control the load and its PF;
iii. means to record measured & and derived parameters;
iv. means to record power system events;
v. means to record performance data; and
vi. means to communicate the recorded data; and
g. a capacitor bank to improve the PF of the load, said capacitor bank is controlled by the RTES.

2. The intelligent controller for management and control of distribution transformer as claimed in claim 1, further comprising means to detect distribution transformer over load and consequently disconnect and re-connect the load so as to prevent failure of distribution transformer.

3. The intelligent controller for management and control of distribution transformer as claimed in claim 1, further comprising means to detect over and under voltage across load terminals and consequently disconnect and re-connect the loads based on the safe limits of the terminal voltages.

4. The intelligent controller for management and control of distribution transformer as claimed in claim 1, further comprising means to detect over current phenomenon in any of the phases and unbalanced current or earth fault and consequently disconnect the loads until manual intervention.

5. The intelligent controller for management and control of distribution transformer as claimed in claim 1, further comprising means to detect phase sequence reversal and activate an alarm, which will reset itself if the phase sequence returns to normalcy.

6. The intelligent controller for management and control of distribution transformer as claimed in claim 1, further comprising means to re-connect loads to the transformer following the interruption of load circuits in a sequential manner with a delay between “switching ON” of the load circuits.

7. The intelligent controller for management and control of distribution transformer as claimed in claim 1, further comprising means to measure and correct the PF by switching capacitor bank.

8. The intelligent controller for management and control of distribution transformer as claimed in claim 1, further comprising means to record and communicate on demand through wired/wireless configuration data, measured and derived parameters, fault records, disturbance records, event records and load low data.

9. The intelligent controller for management and control of distribution transformer as claimed in claim 1, further comprising a friendly MMI and local and remote communication interface wherein the user-enabled settings comprise of not more than the transformer capacity in kVA and line voltage.

10. The intelligent controller for management and control of distribution transformer as claimed in claim 1, which is adequately secured through multi layer authentication.

11. The intelligent controller for management and control of distribution transformer as claimed in claim 1, wherein the transformer used is either oil or air cooled.
